(19) United States
(12) Patent Application Publication
(10) Pub. No.: US 2025/0017364 A1
(43) Pub. Date: Jan. 16, 2025

(54) FOOD SERVICE SYSTEM, METHOD AND SMART FOOD SERVICE CART

(71) Applicant: "RETECH" SPOLKA Z OGRANICZONA ODPOWIEDZIALNOSCIA, Mielec (PL)

(72) Inventors: Krzysztof Ziarko, Mielec (PL); Andrzej Ziarko, Mielec (PL); Boguslaw Ziarko, Murnau (DE); Matthaeus Ziarko, Murnau (DE)

(21) Appl. No.: 18/712,549

(22) PCT Filed: Nov. 22, 2021
(86) PCT No.: PCT/PL2021/050081

§ 371 Date: May 22, 2024

(51) Int. Cl. A47B 31/02; A47B 31/00

(52) U.S. Cl. CPC A47B 31/02; A47B 2031/003; A47B 2031/004; A47B 2031/023

(57) ABSTRACT

A system for preparation and delivery of meals includes a kitchen appliance for cooking or storing food and a food service cart with a frame for carrying meals and a temperature sensor for insertion into the meal. The kitchen appliance and the cart communicate wirelessly with each other. The cart is insertable into the kitchen appliance and includes the temperature sensor, which transmits information to a first communication box, which communicates wirelessly with peripheral devices and transmits the current temperature of the meal, and a second communication box communicates wirelessly with a controller for controlling the kitchen appliance. The second communication box connects to an external power source, and the cart includes an energy storage means. The first communication box allows wireless charging of the energy storage means. A method for preparation and delivery of meals with the use of such a system is also disclosed.

### FIELD OF INVENTION

The present invention relates to a system and an apparatus for food dispensing, wherein prepared or ready-to-eat meals including heated or chilled foods are carried on individual meal trays and/or plates and are held on the trays for a period of time prior to serving the food for eating. More particularly, the invention relates to a system for preparation and delivery of meals, including a kitchen appliance for cooking or storing food and a cart, and to a method of preparing and serving meals.

### STATE OF THE ART

Various food service systems comprising kitchen appliances, in particular gastronomy ovens, and food service carts are known to be used, particularly in restaurants, hospitals, schools and other institutions where large numbers of meals have to be prepared and provided to a range of dispersed locations from a central preparation and/or storage unit. The prepared food needs to be moved from a kitchen or other food preparation area to the area where it is to be consumed, and to ensure that food is effectively transferred, number of conditions have to be met. Generally, food service systems comprise kitchen appliances (gastronomy ovens) and mobile service carts, the carts being provided with frame for trays or plates. The systems enable complete meal trays/plates to be prepared some time before the meals are served, and food in dishes on the trays/plates to be kept warm for serving at the appropriate time. To preserve it during this period, between preparation and serving, the food may be kept warm or, in some solutions, even be heated up on the trays. Some solutions also provide for electronic control units of different types, for example for controlling the operation of the heating devices.

In the currently used solutions, various temperature sensors for measuring the temperature of the food being prepared are used, but these sensors are usually the element of the equipment of the gastronomy oven and are directly coupled with this oven. When the desired temperature is reached, the oven ends the cooking/baking cycle and turns off, and therefore the supervision over the prepared food ends. After opening the oven door, the operator must remember to remove the temperature sensor from the food before the food is put in the cart. To enable further monitoring of the food temperature, there were provided food carts equipped with temperature sensors or systems for warming-up the food in it. Additionally, to prevent too quick cooling down of the food in the cart, thermal insulation covers can be used to maintain the temperature of the food.

For example, EP 1172047 B1 discloses a food service cart with an information-carrying plaque. The cart comprises a frame for receiving metal trays and has a device for heating the meal trays, an electronic control unit for controlling the heating device, and an information plate mounted removably on the frame and on which uncoded information is placed—it has a printed circuit board connected to the electronic control unit to give it instructions. The printed circuit board emits a control signal which is received by an antenna and then transferred to the control unit. This control data could be used for determining when to start the heating and how hot to maintain the temperature of the meals on the trays, or determine the movement of the cart to specific locations where the persons who require the meals are.

Patent No. EP 2144546 B1 discloses a trolley for ready-to-eat meals, comprising a housing and rails for inserting receptacles or trays containing ready-to-eat meals, cooling elements for cooling food, and/or heating or warming-up elements for heating food, wherein the housing has a bottom half-shell that is open at the top and/or a top half-shell which is open at the bottom, the half-shells being movable in a vertical direction within a wheeled frame.

In JP 2009172173 A there is disclosed a food service cart designed to prevent insufficiently heated foods and excessively heated foods from being served by directly measuring the core temperature of the foods in a so-called cook-chill food service cart. This food service cart includes a moving device and the heating device, wherein the heating device has a heat-retaining chamber for storing a plurality of trays, a heater and a fan for heating the foods in the heat-retaining chamber by warm air, at least one temperature sensor provided in the heat-retaining chamber for measuring the core temperature of the foods, a temperature control device, drivingly controlling the heater and the fan based on the measured core temperature of the foods, and a display device connected to the temperature control device for displaying the core temperature of the foods.

Further, GB 2284905 B discloses a method for dispensing food from a mobile trolley and a unit for dispensing food, wherein a portion of food at a first temperature is to be subjected to a temperature change to a second temperature prior to the food being dispensed. The method comprises the following steps: locating a temperature probe in the portion at a representative location, the probe serving to generate an operating signal representative of temperature in the vicinity of the probe; processing the operating signal by way of the signal controller and thereafter; supplying heat to or removing heat from the portion as required to cause the operating signal or a function thereof to change from a value representative of a first temperature towards a value representative of a second temperature; the rate of change being related to a predetermined value. A unit for dispensing food comprises a mobile trolley, a containment on the trolley, heat transfer means for supplying heat to or removing heat from material located in the containment, a probe for location in the containment to detect and to provide an output signal representing a temperature of material in the vicinity of the probe; a signal processor on the trolley, a first transmission means linking the probe to the signal processor, and a second transmission means linking the signal processor to the heat transfer means, the signal processor being enabled to govern operation of the heat transfer means as a function of the output signal.

### SUMMARY OF THE INVENTION

In the current solutions known from the state of the art, as can be seen from the above examples, temperature sensors are commonly used in food carts for measuring the temperature of the food. However, the problem of continuous temperature monitoring remains unsolved—when the desired temperature in the kitchen appliance (in particular a gastronomy oven) is reached, it ends the cycle and turns off, ending the supervision over the prepared food. After opening the kitchen appliance door, the operator must remember to remove the temperature sensor from the food, and then to move the food onto the food cart insertion of the temperature sensors in the food again. Therefore, the food temperature is not monitored constantly and, what is more, the operation of removing the kitchen appliance's temperature sensors from the food, moving the food onto cart and, afterwards, inserting the cart's temperature sensors in the food for a second time, is very time-consuming and labour-intensive. Furthermore, with each sensor installed in the kitchen appliance, the risk of forgetting to remove it from the meals and tearing the cable out while removing the meals from the kitchen appliance increases, as well as the risk of leakage in the kitchen appliance chamber and of damaging the electrical and electronic connections controlling the kitchen appliance.

To overcome said inconveniences, there is provided a system for preparation and delivery of meals, including a kitchen appliance for cooking or storing food using heating or cooling processes, in particular a gastronomy oven or a refrigerator, and a smart food service cart, and a method of preparing and serving meals using this system. The smart food service cart comprises an at least one food temperature sensor and can be placed in the kitchen appliance together with the food. Thanks to that, the sensor can remain in the food all the time, i.e. beginning from the insertion of the service cart with food to the kitchen appliance, up to the moment just before serving—in other words, it can monitor the food temperature until it is taken out of the service cart and served on the table. Using the temperature sensor for constant monitoring of food temperature and, additionally and preferably, the thermal insulating cover, allows the food to be protected from contamination and deterioration while being maintained within a predetermined temperature range and ensuring that it will eventually be in a condition which is attractive to consumers.

The present invention discloses a system for preparation and delivery of meals, comprising a kitchen appliance for cooking or storing food using heating or cooling processes, in particular a gastronomy oven or a refrigerator, and a food service cart with a frame for carrying meals placed on trays, plates, racks or the like and with an at least one temperature sensor designed to be inserted into the meal, wherein the kitchen appliance and the smart food service cart are designed to communicate with each other, the smart food service cart being designed to be inserted into a cooking chamber of the kitchen appliance, wherein:
the cart and the kitchen appliance are provided with, respectively, a first communication box and a second communication box, whereby the communication boxes communicate with each other wirelessly;
the cart is provided with the at least one temperature sensor for measuring temperature of the meal, the information being transferred from the at least one temperature sensor to at least the first communication box;
whereby the first communication box communicates wirelessly with peripheral devices and transmits information referring to the current temperature of the meal, measured by the at least one temperature sensor, to said peripheral devices, and
the second communication box communicates wirelessly with a means for controlling the kitchen appliance, and
the second communication box is connected to an external power source, and
the cart is provided with an energy storage means, and
the first communication box, when placed near the second communication box, allows wireless charging of the energy storage means.

Preferably, the at least one temperature sensor transfers information to the first communication box by wire.

Preferably, in order to transfer information, the at least one temperature sensor is connected to respective number of sockets in the post of the cart's frame, the sockets being connected by the wires guided inside the cart's frame, and therefore being connected with the first communication box. Preferably, the temperature sensor is connected to the socket by means of a plug, preferably a conventional plug or a magnetic plug with the help of the system for magnetic centring of the plug.

Preferably, the first communication box transmits to the peripheral device information about how much time is left until the preset minimum temperature of the meal below which serving of the meal should be avoided, is reached.

Preferably, the first communication box communicates with mobile devices, such as a smartphone, a tablet, a computer, a server or an electronic panel attached to the cart.

Preferably, the first communication box and the second communication box are located on the same level such that they can come close to each other, preferably in the bottom of the cart and kitchen appliance, respectively, on one of their left or right sides.

Preferably, the wireless charging of the energy storage means via communication boxes is realised as inductive charging.

Preferably, the communication boxes communicate with each other and peripheral devices by means of WiFi or Bluetooth.

Preferably, the system further includes a thermo-insulating cover for covering the cart, the thermo-insulating cover being equipped with an electronic panel for wireless communication with the first communication box, whereby said panel is configured to display various information received from the first communication box.

Preferably, the electronic panel is configured to signal the moment of reaching the minimum temperature of the meal, preferably by sound or light signal.

Preferably, the electronic panel communicates wirelessly with peripheral devices, preferably a smartphone, a tablet a computer or a server.

The present invention discloses also a method for preparation and delivery of meals with the use of a system described above, wherein the cart with the at least one temperature sensor already inserted into the at least one meal is placed in the kitchen appliance, the method comprising the following steps:
(i) placing the at least one meal in the cart;
(ii) inserting the at least one temperature sensor into the at least one meal;
(iii) inserting the service cart, together with the at least one meal with the at least one temperature sensor being inserted into the meal, into the cooking chamber of the kitchen appliance (10);
(iv) while the cart is inside the kitchen appliance, charging the energy storage means via the first communication box, the first communication box being in contact with the second communication box that is connected to a power source;
(v) taking out the cart from the kitchen appliance, with the at least one temperature sensor still remaining inserted into the meal;
whereby the temperature of the at least one meal is constantly monitored from the moment of placing the cart in the kitchen appliance up to the moment of serving by means of the at least one temperature sensor transmitting the information to the first communication box, and;
whereby the first communication box wirelessly transmits information about the temperature of the at least one meal to one or more of the peripheral devices, preferably via Bluetooth or WiFi.

Preferably, after the cart is removed from the kitchen appliance, it is covered by the thermo-insulating cover equipped with the electronic panel, whereby the electronic panel communicates with the first communication box and displays various information received from the first communication box, such as information about the current temperature of the meal and information about how much time is left until the preset minimum temperature of the meal is reached.

Preferably, the electronic panel signals the moment of reaching the preset minimum temperature of the meal below which serving of the meal should be avoided by a signal, preferably a sound or a light signal.

### DETAILED DESCRIPTION

The subject of the invention is a system for preparation and delivery of meals, including a kitchen appliance for cooking or storing food using heating or cooling processes, in particular a gastronomy oven or a refrigerator, and a smart food service cart being also the subject of the invention, and a method of preparing and serving meals using this system. The system and the smart food service cart will be described with more detail below, with reference to the attached drawing, wherein:

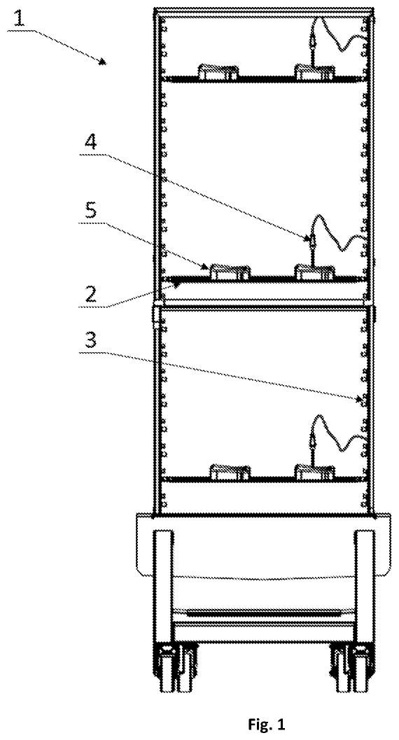

FIG. 1 shows a tray-type cart in front-view;

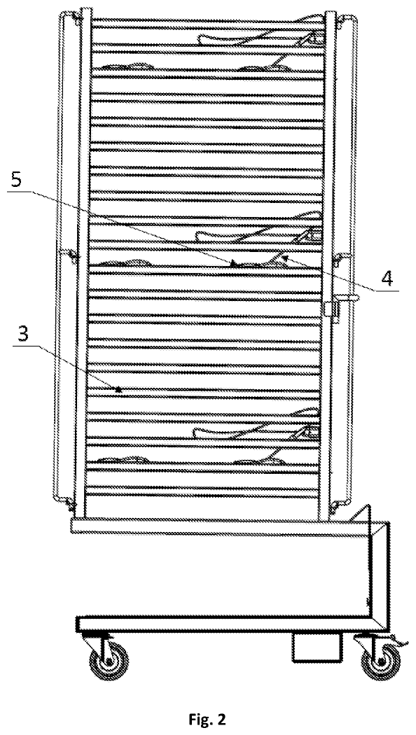

FIG. 2 shows a tray-type cart in side-view;

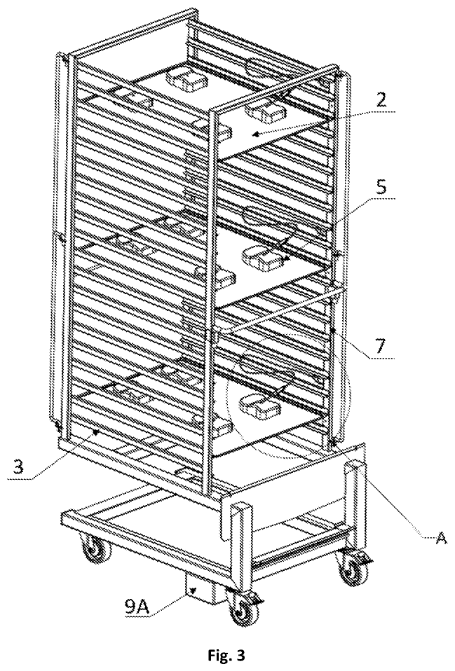

FIG. 3 shows the cart in an angled view;

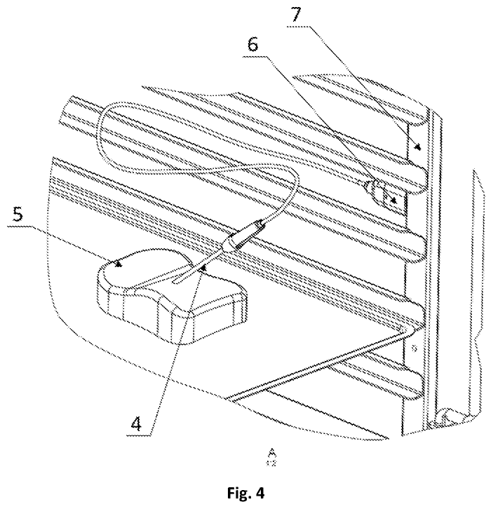

FIG. 4 shows a close-up view of part A of FIG. 3;

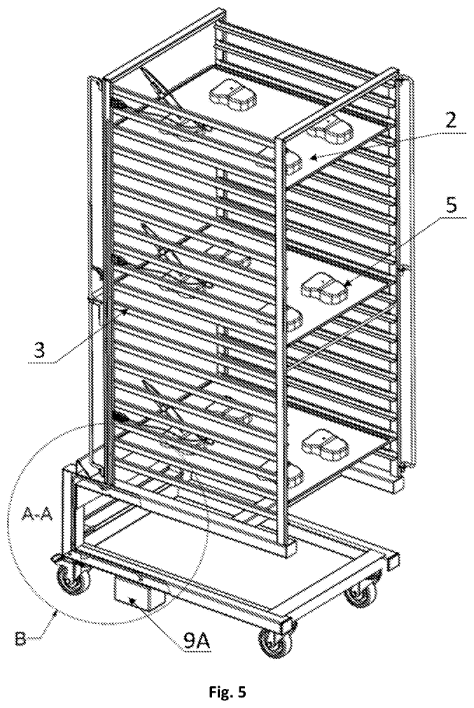

FIG. 5 shows the cart in an angled view, from the opposite side than in FIG. 3;

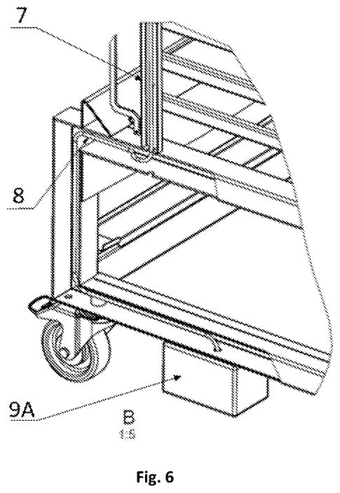

FIG. 6 shows a close-up view of part B of FIG. 5;

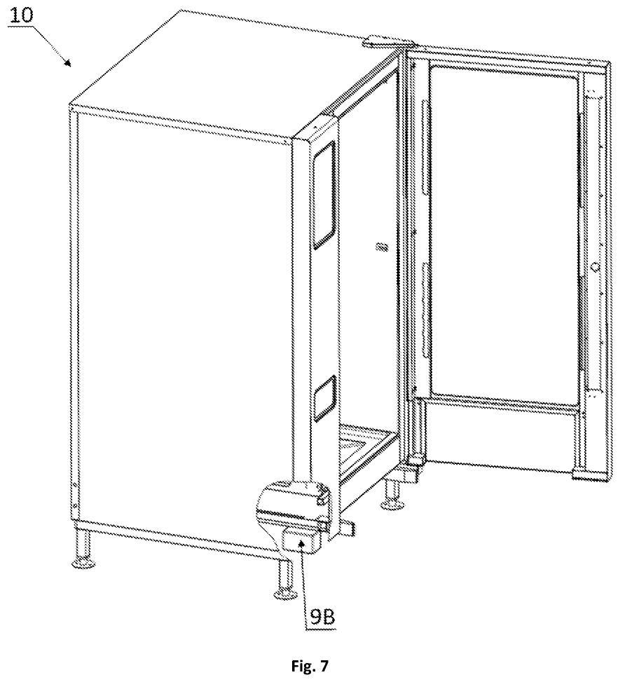

FIG. 7 shows the kitchen appliance—gastronomy oven;

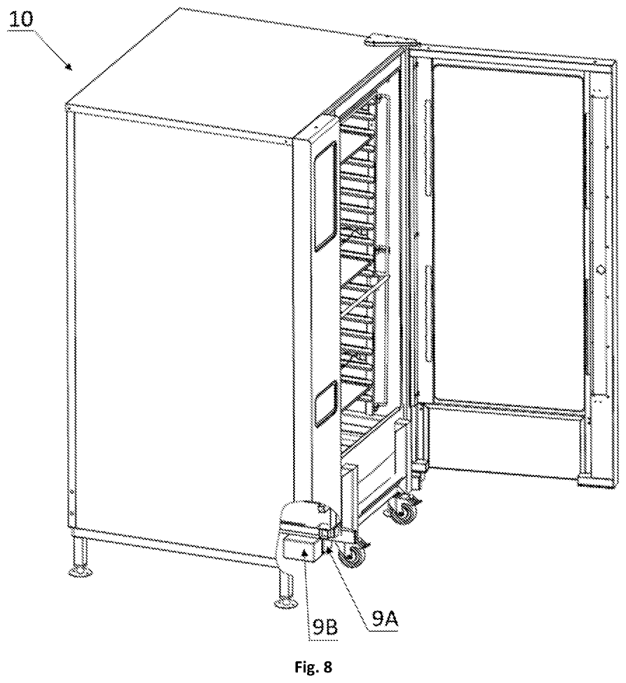

FIG. 8 shows the kitchen appliance—gastronomy oven—with the cart placed inside;

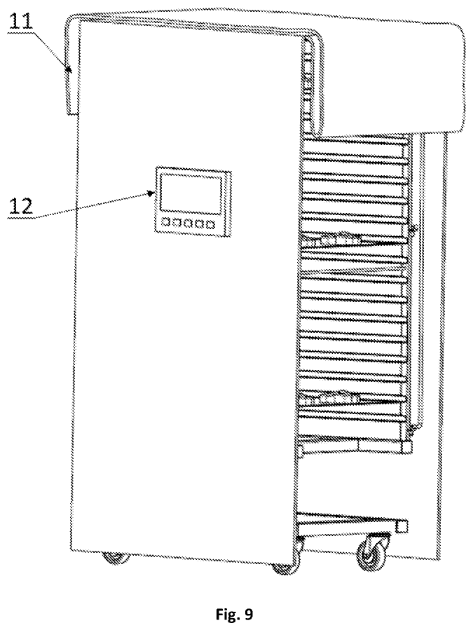

FIG. 9 shows the cart partially covered with a thermo-insulating cover.

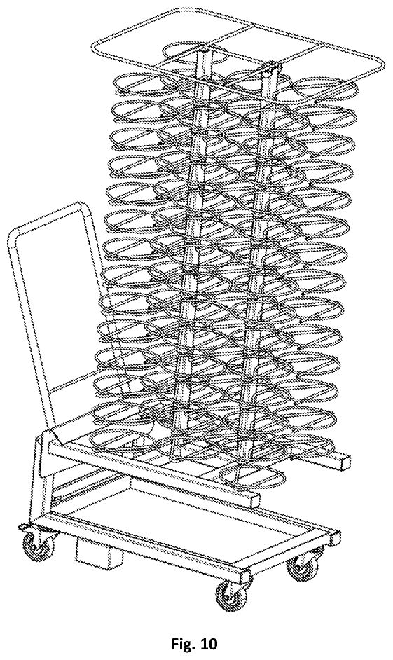

FIG. 10 shows a plate-type smart food service cart.

In the drawing, the following numerical indications have been used:
1—smart food service cart; 2—tray; 3—slot; 4—temperature sensor; 5—meal; 6—plug; 7—cart's post; 8—wires; 9A—first communication box; 9B—second communication box; 10—kitchen appliance; 11—thermo-insulating cover; 12—electronic panel.

The system for preparation and delivery of meals comprises generally a smart food service cart 1 and a kitchen appliance 10.

The smart food service cart 1 may be a tray-type smart food service cart, shown in the embodiment from FIGS. 1-9, or plate-type smart food service cart, shown in FIG. 10.

FIG. 1 and FIG. 2 show a tray-type cart 1 of the construction known from the state of the art, in front-view and side-view, respectively, with trays 2 inserted in slots 3. The slots 3 are arranged in known manner in the cart 1 frame. According to the invention, the cart 1 has at least one temperature sensor 4, which is designed to be inserted into the meal 5. Preferably, the number of the temperature sensors 4 is smaller than the number of the trays 2 and/or meals 5. For example, if there are all trays 2 placed in the slots 3 of the cart 1, there will be from three to six sensors 4. More precisely, first sensor 4 can be placed in the bottom of the cart 1, second sensor 4 can be placed in the middle of the cart 1 and third sensor 4 may be placed at the top of the cart 1. Such an arrangement allows to monitor the temperature from the upper part of the cart 1 to its bottom. In another, less preferable embodiment, and as illustrated in the Figures, the number of temperature sensors 4 can also correspond to the number of trays 2 inserted in the slots 3 of the cart 1 at the moment. In this case, there are three trays 2 in the cart 1 and three temperature sensors 4. In another embodiment, the number of the temperature sensors 4 may for example correspond to the number of meals 5 placed in the cart 1.

FIG. 3 shows the cart 1 in an angled view, with three trays 2 inserted in slots 3.

FIG. 4 shows a close-up view of part A of FIG. 3. In this figure it can be clearly seen, that the temperature sensor 4, by means of a plug 6, is connected to a socket (not shown) in the post 7 (frame) of the cart 1. In another embodiments, the temperature sensor 4 may be connected to the socket by means of a magnetic plug with the help of the system for magnetic centring of the plug, such systems being known in the art. In one embodiment, the socket, and therefore the plug 6, is provided on the post 7 above the corresponding tray 2, from the side facing the other post 7 on the opposite side of the cart 1 (along the longer side), and arranged vertically. However, this arrangement is not limiting—one can imagine that the plug 6 is inserted in the socket provided on any other side of the generally rectangular post 7 and arranged horizontally (or vertically)—any suitable combination of positions is possible.

FIG. 5 shows the cart 1 in an angled view, similarly as in FIG. 3, but illustrated from the opposite side.

FIG. 6 shows a close-up view of part B of FIG. 5. In this FIG. 6 there are illustrated the wires 8, guided inside the cart 1 frame structure. The wires 8 are provided to connect the sockets, and therefore the temperature sensors 4, with the communication box 9A. Communication box 9A is intended for communicating with the means for controlling the kitchen appliance 10 (through the second communication box 9B) and with other mobile and charging devices. For instance, communication box 9A allows wireless charging of the cart's 1 accumulator (not shown).

In yet another embodiment, the temperature sensor(s) 4 may be designed do transfer the information wirelessly, preferably via Bluetooth or WiFi, directly to the first communication box 9A (alternatively, to communication box 9A and/or communication box 9B). In such an arrangement there will not be any wires 8 or sockets.

FIG. 7 shows the kitchen appliance 10, here being the gastronomy oven. The kitchen appliance 10 is provided with second communication box 9B, in this embodiment located in the bottom of the oven 10, on one of its left or right sides. The communication box 9B is connected to the power source (not shown), which further allows wireless charging of the cart's 1 accumulator (not shown).

FIG. 8 shows the kitchen appliance 10 (gastronomy oven) with the cart 1 placed inside. As can be seen, both have a communication box on the lower side, communication box 9B and 9A, respectively. After the cart is inserted, the communication boxes 9A, 9B come in contact with each other, what allows them to communicate and to wirelessly charge the accumulator of the cart 1, since communication box 9B is joined with the power source. In the present embodiment, wireless charging is realised as inductive charging. Both communication boxes 9A and 9B are communicating with other devices wirelessly, for example by means of WiFi or Bluetooth. The communication between the communication boxes 9A and 9B is also necessary to transfer information between the cart 1 and the kitchen appliance 10, for example from the cart 1 to the control means of the kitchen appliance 10.

FIG. 9 shows the cart 1 partially covered with a thermo-insulating cover 11. The thermo-insulating cover 11 is equipped with electronic panel 12 for wireless communication with the communication box 9A of the cart 1. In this embodiment, panel 12 is provided on one of the lateral sides of the thermo-insulating cover 11. On this panel 12 there would be displayed various information: information about the current temperature of the meal 5, measured by temperature sensor(s) 4, and information about how much time is left until the preset minimum temperature is reached, beyond which temperature the meal 5 can be considered too cold to serve. The information can be assigned only to one meal 5 or to a number of meals, depending on how many temperature sensors 4 are inserted into the meals. Additionally, the panel 12 can signal the moment of reaching the minimum temperature by, for example, sound or light signal. One can also imagine that this panel 12, and/or the communication box 9A, would communicate wirelessly with other devices, such as, for example, a smartphone or a computer.

FIG. 10 shows a plate-type cart, having places designed for receiving plates, instead of slots 3 designed for receiving trays 2. This type of cart, or any other that can be used, are part of the system for preparation and delivery of meals according to the invention.

The present invention relates also to a method for preparing and serving meals with the use of the system described above. The first step of this method is placing the meal(s) 5 on the tray 2 in the cart 1. In case of the use of the plate-type cart, meals are placed on a place for plates. The second step is to insert the temperature sensors 4 into the meals 5, in any appropriate number. For example, if there are three different meals on different trays, three sensors 4 may be used but, depending on circumstances, only one temperature sensor 4 may be used. Further, the cart 1, together with meals 5 with temperature sensors 4 inserted, is put into the kitchen appliance 10 (here—in this particular embodiment—into the gastronomy oven; in another embodiment, for example into the refrigerator). The temperature sensors 4 monitor the food temperature in the kitchen appliance 10. While the cart 1 is in the kitchen appliance 10, the communication box 9A of the cart 1 is charged wirelessly when in contact with communication box 9B of the kitchen appliance 10, what is possible since the communication box 9B is connected to a power source. When the food processing (here: cooking or baking)/storing is finished, the cart 1 is taken out from the kitchen appliance 10, and the temperature sensors 4 still remain in the food. Before the meals 5 are served, the temperature of the food is constantly monitored—the temperature sensors 4 are connected with plug 6 to a socket, and further, by wires guided through the cart's 1 frame, to the communication box 9A (analog signal). The communication box 9A may further send information about food temperature to another periphery device, such as a smartphone, wirelessly, for example via Bluetooth or WiFi. The communication box 9A may also further send the information (digital information) to the second communication box 9B, which may in turn transfer the information to the control means of the kitchen appliance 10. Additionally, after the cart 1 is removed from the kitchen appliance 10 (e.g. oven), it may be covered by the thermo-insulating cover 11, which allows to maintain higher temperature of the meal for a relatively long time. This thermo-insulating cover 11 is equipped with electronic panel 12, communicating with the communication box 9A. On this panel 12 there are displayed various information gained from the communication box 9A and/or 9B, such as information about the current temperature of the meal 5, measured by temperature sensor(s) 4, and information about how much time is left until the minimum temperature is reached, beyond which temperature the meal 5 cannot be served because they are too cold yet. The information can be assigned only to one meal 5 or to a number of meals, depending on how many temperature sensors 4 are inserted into the meals. In one embodiment, the panel 12 can signal the moment of reaching the minimum temperature by sound or light signal, or other appropriate signal.

The advantages of the present invention are numerous. Generally, it allows smooth monitoring of the food from the moment of beginning of the cooking, through keeping it warm outside the kitchen appliance (in particular a gastronomy oven), also under the thermo-insulating cover, until the moment it is served. The system according to the invention comprises a smart food service cart which enters the kitchen appliance with meals, so there is no need to transfer food from the kitchen appliance to the cart, one by one. Unlike in the known solutions, the temperature of food outside the cooking process can be therefore monitored without the need to remove the sensors already inserted into the food (as it was stated before, in known solutions, when removing food from the kitchen appliance, temperature sensors must be removed from it). Moreover, in known solutions, the temperature sensors were inserted from outside, which was very inconvenient and problematic. Thanks to the present invention, there is no need to make holes in the wall of the kitchen appliance and making a tight cable passage through this wall, which makes the present invention more economical and ecological. What is more, the cart operates wirelessly, i.e. it does not require a power supply from stationary sockets—it has no heating elements and only requires wireless charging of the internal accumulator, which is realised while the cart is in the kitchen appliance. The monitoring of the system consists in constant informing the user about the current temperature of meals and predicting the time remaining until the minimum temperature at which meals must be served is reached. By the use of communication boxes, an easy-to-use monitoring of multiple measurement points is provided, which was so far not feasible in an oven because: there would have to be more openings in the wall of the kitchen appliance with sealing means for sealing the passage through the wall of the kitchen appliance; with each sensor installed in the kitchen appliance, the risk of forgetting to remove it from the meals and tearing the cable out when removing the meals from the kitchen appliance increases and the risk of leakage in the kitchen appliance chamber, which causes the risk of damaging the electrical and electronic connections controlling it.

1-15. (canceled)

16. A system for preparation and delivery of meals, comprising a kitchen appliance for cooking or storing food using heating or cooling processes, in particular a gastronomy oven or a refrigerator, and a food service cart with a frame for carrying meals placed on trays, plates, racks or the like and with an at least one temperature sensor designed to be inserted into the meal, wherein the kitchen appliance (10) and the smart food service cart (1) are designed to communicate with each other, the smart food service cart (1) being designed to be inserted into a chamber of the kitchen appliance (10), wherein:
the cart (1) and the kitchen appliance (10) are provided with, respectively, a first communication box (9A) and a second communication box (9B), whereby the communication boxes (9A, 9B) communicate with each other wirelessly;
the cart (1) is provided with the at least one temperature sensor (4) for measuring temperature of the meal (5), the information being transferred from the at least one temperature sensor (4) to at least the first communication box (9A),
whereby the first communication box (9A) communicates wirelessly with peripheral devices and transmits information referring to the current temperature of the meal (5), measured by the at least one temperature sensor (4), to said peripheral devices, and
the second communication box (9B) communicates wirelessly with a means for controlling the kitchen appliance (10), and
the second communication box (9B) is connected to an external power source, and
the cart (1) is provided with an energy storage means, and
the first communication box (9A), when placed near the second communication box (9B), allows wireless charging of the energy storage means.

17. The system according to claim 16, wherein the at least one temperature sensor (4) transfers information to at least the first communication box (9A) by wire.

18. The system according to claim 17, wherein in order to transfer information, the at least one temperature sensor (4) is connected to respective number of sockets in the post (7) of the cart's (1) frame, the sockets being connected by the wires (8) guided inside the cart's (1) frame, and therefore being connected with the first communication box (9A).

19. The system according to claim 17, wherein the temperature sensor (4) is connected to the socket by means of a plug (6) the help of the system for magnetic centring of the plug.

20. The system according to claim 16, wherein the first communication box (9A) transmits to the peripheral device information about how much time is left until the preset minimum temperature of the meal (5) below which serving of the meal should be avoided, is reached.

21. The system according to claim 16, wherein the first communication box (9A) communicates with a mobile devices selected from the group consisting of a smartphone, a tablet, a computer, a server or an electronic panel attached to the cart (1).

22. The system according to claim 16, wherein the first communication box (9A) and the second communication box (9B) are located on the same level such that they can come close to each other, respectively, on one of their left or right sides.

23. The system according to claim 16, wherein the wireless charging of the energy storage means via communication boxes (9A, 9B) is realised as inductive charging.

24. The system according to claim 16, wherein the communication boxes (9A, 9B) communicate with each other and peripheral devices by means of WiFi or Bluetooth.

25. The system according to claim 16, wherein it further includes a thermo-insulating cover (11) for covering the cart (1), the thermo-insulating cover (11) being equipped with an electronic panel (12) for wireless communication with the first communication box (9A), whereby said panel (12) is configured to display various information received from the first communication box (9A).

26. The system according to claim 25, wherein the electronic panel (12) is configured to signal the moment of reaching the minimum temperature of the meal (5).

27. The system according to claim 25, wherein the electronic panel (12) communicates wirelessly with a peripheral device selected from the group consisting of a smartphone, a tablet a computer or a server.

28. A method for preparation and delivery of meals with the use of a system according to claim 16, wherein the cart (1) with the at least one temperature sensor (4) already inserted into the at least one meal (5) is placed in the kitchen appliance (10), the method comprising the following steps:
(i) placing the at least one meal (5) in the cart (1);
(ii) inserting the at least one temperature sensor (4) into the at least one meal (5);
(iii) inserting the service cart (1), together with the at least one meal (5) with the at least one temperature sensor (4) being inserted into the meal (5), into the cooking chamber of the kitchen appliance (10);
(iv) while the cart (1) is inside the kitchen appliance (10), charging the energy storage means via the first communication box (9A), the first communication box (9A) being in contact with the second communication box (9B) that is connected to a power source;
(v) taking out the cart (1) from the kitchen appliance (10), with the at least one temperature sensor (4) still remaining inserted into the meal (5);
whereby the temperature of the at least one meal (5) is constantly monitored from the moment of placing the cart (1) in the kitchen appliance (10) up to the moment of serving by means of the at least one temperature sensor (4) transmitting the information to the first communication box (9A), and;
whereby the first communication box (9A) wirelessly transmits information about the temperature of the at least one meal (5) to one or more of the peripheral devices.

29. The method according to claim 28, wherein after the cart (1) is removed from the kitchen appliance (10), it is covered by the thermo-insulating cover (11) equipped with the electronic panel (12), whereby the electronic panel (12) communicates with the first communication box (9A) and displays various information received from the first communication box (9A), such as information about the current temperature of the meal (5) and information about how much time is left until the preset minimum temperature of the meal (5) is reached.

30. The method according to claim 29, wherein the electronic panel (12) signals the moment of reaching the preset minimum temperature of the meal (5) below which serving of the meal (5) should be avoided by a signal.
